(19) United States
(12) Patent Application Publication
(10) Pub. No.: US 2026/0229127 A1
(43) Pub. Date: Aug. 6, 2026

(54) OPERATION MANAGEMENT DEVICE

(71) Applicant: HITACHI, LTD., Tokyo (JP)

(72) Inventors: Nobuyasu KANEKAWA, Tokyo (JP); Kazuki MATSUO, Tokyo (JP); Hironobu YAMAKAWA, Tokyo (JP); Mikio BANDO, Tokyo (JP)

(21) Appl. No.: 19/152,518

(22) PCT Filed: Jan. 12, 2024
(86) PCT No.: PCT/JP2024/000679

§ 371 Date: Jul. 31, 2025

(30) Foreign Application Priority Data
Mar. 3, 2023 (JP) 2023-033007

(51) Int. Cl. G08G 5/30

(52) U.S. Cl. CPC G08G 5/30

(57) ABSTRACT

The objective of the present invention is to provide an aircraft operation management device capable of determining a flight path with which noise does not cause a problem, using a small amount of calculation. The operation management device is a device for determining the flight path of an aircraft and performing operation management of the aircraft. The operation management device is preset with airframe noise level information that indicates, for each aircraft, an airframe noise level, which is the level of noise emitted by the aircraft. The operation management device identifies a flyable region representing an airspace in which the aircraft can fly, in accordance with the airframe noise level of the aircraft for which the flight path is to be determined. The operation management device determines the flight path of the aircraft on the basis of the identified flyable region.

### TECHNICAL FIELD

The present invention relates to an operation management device of a flight vehicle.

### BACKGROUND ART

Flights beyond the visual contact of flight vehicles, including unmanned airplanes such as drones, are permitted and approved in the Japan's current aviation law on the condition of involving an assistant who manages third-party accesses, monitors the owned flight vehicle and manned airplanes, and monitors the weather around the owned flight vehicle, for example. In the future, there is a move to permit and approve flights beyond visual contact. For this purpose, at least the role of the assistant will require being replaced with the flight vehicle or ground facilities. There may be a critical need for operation management devices that enable flight vehicles to operate safely and efficiently. The operation management device is required to settle flight routes of the flight vehicle so that the flight vehicle can fly safely and efficiently. This type of operation management device or its functions are also referred to as UTM (Unmanned Aerial System Traffic Management).

In the future, noise emitted from flight vehicles is expected to become a problem as flights beyond visual contact are approved and the flight vehicles become more widespread. Patent Literature 1 is known as prior art to settle the flight routes of the flight vehicle from the viewpoint of noise.

### CITATION LIST

### Patent Literature

Patent Literature 1: Japanese Unexamined Patent Application Publication No. 2021-21616

### SUMMARY OF INVENTION

### Technical Problem

The technology disclosed in Patent Literature 1 needs to evaluate the amount of noise at each of multiple points on a candidate route to settle a flight route considering the sonic environment in areas along the flight route. If there are many flight route candidates, the technology disclosed in Patent Literature 1 needs to evaluate the amount of noise at many points, requiring a huge amount of calculation of an operation management device.

The present invention has been made in consideration of the foregoing. It is therefore an object of the present invention to provide a flight vehicle operation management device capable of settling the flight routes free from a noise problem based on a small amount of calculation.

### Solution to Problem

To solve the above-described issue, an operation management device according to the present invention settles a flight route of a flight vehicle and performs operation management on the flight vehicle. Airframe noise level information is preliminarily set for each of the flight vehicles to indicate an airframe noise level as a level of the noise emitted from the flight vehicle. A flyable domain is identified to indicate an air area in which the flight vehicle can fly, according to the airframe noise level of the flight vehicle for which the flight route is to be settled. The flight route of the flight vehicle is settled based on the identified flyable domain.

### Advantageous Effects of Invention

The present invention can provide a flight vehicle operation management device capable of settling flight routes free from a noise problem based on a small amount of calculation. Objects, configurations, and effects other than the above will be apparent from the description of the following embodiments.

### BRIEF DESCRIPTION OF DRAWINGS

FIG. 1 is a diagram illustrating an operation management device.

FIG. 2 is a diagram illustrating a functional configuration of the operation management device illustrated in FIG. 1.

FIG. 3 is a diagram illustrating a hardware configuration of the operation management device illustrated in FIG. 2.

FIG. 4 is a flowchart illustrating a process performed by the operation management device illustrated in FIG. 2.

FIG. 5 is a diagram explaining an example of dividing an air area by using voxels.

FIG. 6 is a diagram illustrating a flight plan generated based on the voxels illustrated in FIG. 5.

FIG. 7 is a diagram explaining an example of dividing the air area by using corridors.

FIG. 8 is a diagram illustrating a flight plan generated based on the corridors illustrated in FIG. 7.

FIG. 9 is a diagram illustrating flyable domain information.

FIG. 10 is a diagram illustrating flight route settlement based on the flyable domain information.

FIG. 11 is a diagram illustrating a table defining the relationship between an airframe noise level and the isolation distance.

FIG. 12 is a diagram illustrating an isolation distance, considering the presence or absence of a wall adjacent to flight vehicles.

FIG. 13 is a diagram illustrating a table defining the relationship between the airframe noise level and the isolation distance when there is a wall adjacent to the flight vehicle in the horizontal direction of the flight vehicle.

FIG. 14 is a diagram illustrating an isolation distance, considering the flight phases of the flight vehicle.

FIG. 15 is a diagram illustrating an isolation distance, considering the directivity of the noise emitted from the flight vehicle.

FIG. 16 is a diagram illustrating the restriction on flight altitudes of the flight vehicle.

FIG. 17 is a diagram illustrating the installation of an arrival and departure port for the flight vehicle in a location close to the site.

FIG. 18 is a diagram illustrating the installation of the arrival and departure port for the flight vehicle on a balcony of a housing complex.

FIG. 19 is a diagram illustrating the installation of the arrival and departure port for the flight vehicle in the housing complex.

FIG. 20 is a diagram illustrating the flight vehicle flying in an air area above a road.

FIG. 21 is a view of FIG. 20 in the X direction.

FIG. 22 is a diagram illustrating a difference in the flight routes depending on the airframe noise levels.

FIG. 23 is a diagram illustrating the operation management device that performs route pricing.

FIG. 24 is a diagram illustrating the charging information illustrated in FIG. 23.

### DESCRIPTION OF EMBODIMENTS

Hereinafter, one embodiment of the present invention will be described with reference to the accompanying drawings. Unless otherwise specified, configurations or functions designated by the same reference numerals in the embodiments have the same configurations or functions in the embodiments, and the description thereof will be omitted for brevity.

### First Embodiment

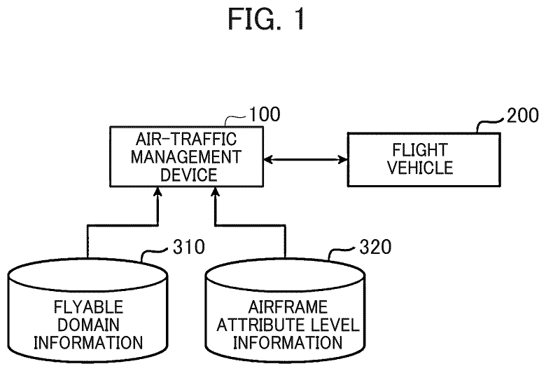

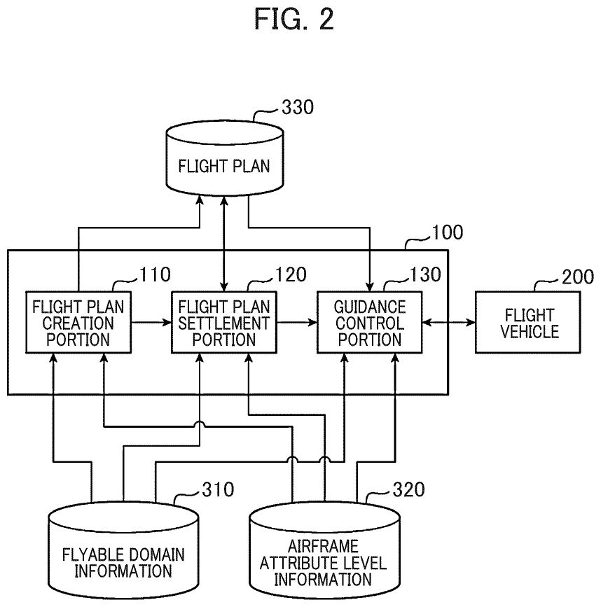

A first embodiment explains a basic embodiment of an operation management device. FIG. 1 is a diagram illustrating the operation management device. FIG. 2 is a diagram illustrating a functional configuration of the operation management device illustrated in FIG. 1.

An operation management device 100 performs operation management and flight control over a flight vehicle 200, including unmanned aerial vehicles such as drones. The operation management device 100 may be a ground facility that configures a UTM. The operation management device 100 may also be referred to as a control device for the flight vehicle 200.

The operation management device 100 performs operation management and flight control over the flight vehicle 200 based on flyable domain information 310 and airframe noise level information 320. Specifically, the operation management device 100 generates a flight plan 330 including the flight routes of the flight vehicle 200 based on the flyable domain information 310 and the airframe noise level information 320. The operation management device 100 approves and registers the generated flight plan 330 to finalize the flight plan 330. The operation management device 100 guides and controls the flight vehicle 200 to fly according to the finalized flight plan 330. As illustrated in FIG. 2, the operation management device 100 includes a flight plan generation portion 110, a flight plan finalization portion 120, and a guidance control portion 130.

The flight plan generation portion 110 generates the flight plan 330 for the flight vehicle 200. The flight plan 330 includes at least a flight route from the departure place (also referred to as a starting point including the sky above) to the arrival place (also referred to as an arrival point including the sky above) of the flight vehicle 200 and a scheduled time of passage (including the scheduled times of departure and arrival) of the air area through which the flight route passes. The flight plan generation portion 110 settles the flight route and generates the flight plan 330 based on the flyable domain information 310 and the airframe noise level information 320. Namely, the flight plan generation portion 110 settles the flight route for the flight vehicle 200 and generates the flight plan 330 based on the flyable domain corresponding to the airframe noise level of the target flight vehicle 200.

The airframe noise level information 320 indicates the level of noise (hereinafter also referred to as “airframe noise level”) generated from the flight vehicle 200 according to each flight vehicle 200. The airframe noise level information 320 is preliminarily set and stored in the operation management device 100. The airframe noise level may represent a noise (sound pressure) level measured at a position a predetermined distance away from the flight vehicle 200. In particular, the airframe noise level may represent the noise (sound pressure) level measured by using a frequency weighting characteristic considering human hearing. The frequency weighting characteristic considering account human hearing may be represented as an equal loudness level curve defined in ISO 226:2003, for example.

The airframe noise level may represent the acoustic power level of the flight vehicle 200. The acoustic power level represents the amount of acoustic energy emitted per unit time from the flight vehicle 200 as a sound source. The acoustic power level is calculated by applying an area integral to the acoustic intensity on a closed surface that surrounds the flight vehicle 200 as a sound source. The present embodiment uses three or more airframe noise levels as the airframe noise level information 320.

The flyable domain information 310 represents a domain (hereinafter also referred to as a “flyable domain”) in which the flight vehicle 200 can fly within the air area managed by the operation management device 100. The flyable domain information 310 is represented by information on voxels (or corridors) as unit air areas that divide the air area. The flyable domain information 310 may include restriction level information that restricts the flight of the flight vehicle 200. The restriction level is used to define a flight restriction domain such as the surround (including the sky above) of a facility to be protected from noise or an important facility, for example. The flyable domain information 310 is predefined for each airframe noise level.

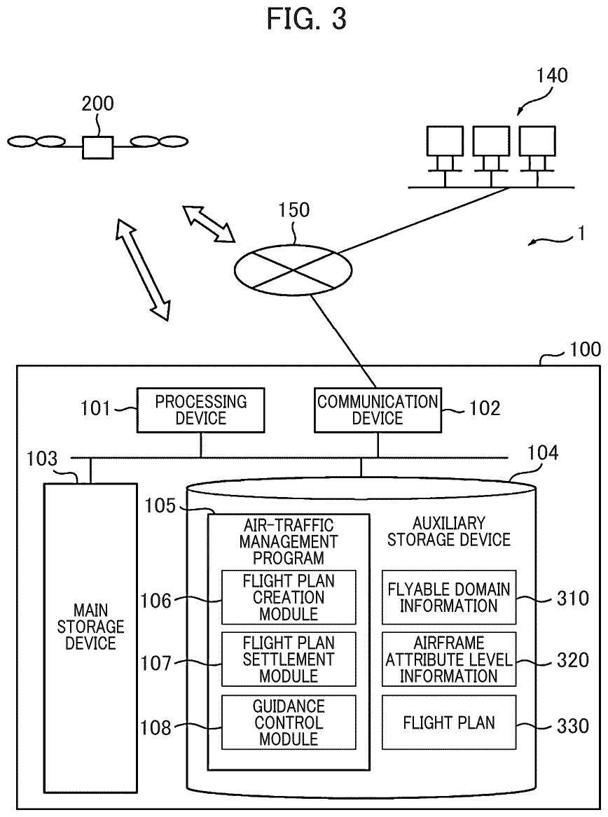

FIG. 3 is a diagram illustrating the hardware configuration of the operation management device illustrated in FIG. 2.

FIG. 3 illustrates the system configuration of an operation management system 1 including the operation management device 100. The operation management device 100 is connected to the flight vehicle 200 and a terminal device group 140 via a network 150. The operation management device 100 represents a computer, such as a server device in a cloud or local system. The operation management device 100 includes a processing device 101, a communication device 102, a main storage device 103, and an auxiliary storage device 104. These are mutually connected via communication paths.

The processing device 101 represents a processor such as a CPU (Central Processing Unit). The processing device 101 performs calculations according to an operation management program 105 stored in the auxiliary storage device 104.

The communication device 102 provides the interface function of the operation management device 100 with the outside. The communication device 102 receives input from users of the terminal device group 140 and transmits contents to be displayed on the terminal device group 140 via the network 150.

The communication device 102 communicates with the flight vehicle 200 via the network 150 or directly. Specifically, the communication device 102 transmits control signals to the flight vehicle 200 to guide the flight of the flight vehicle 200 according to the calculations of the processing device 101. The communication device 102 receives information indicating flight situations (including the flight position, route, or attitude) from the flight vehicle 200.

The main storage device 103 is supplied with the operation management program 105 stored in the auxiliary storage device 104 and information used for calculations of the processing device 101. The auxiliary storage device 104 represents a so-called storage. The auxiliary storage device 104 represents various storage media such as an external HDD (Hard Disk Drive), SSD (Solid State Drive), or memory card. The auxiliary storage device 104 may represent a device such as a file server separate from the operation management device 100. The auxiliary storage device 104 stores the operation management program 105, the flyable domain information 310, the airframe noise level information 320, and the flight plan 330. The auxiliary storage device 104 also stores other information such as flight-related information (to be described). The flyable domain information 310, the airframe attribute level information 320, and the flight plan 330 may be stored in a device other than the operation management device 100.

The operation management program 105 is modularized on a function basis and may be composed of a flight plan generation module 106, a flight plan finalization module 107, and a guidance control module 108. Each of these modules represents an individual program or a combination thereof. The operation management device 100 may represent multiple devices that are divided according to their functions.

The flight plan generation module 106, the flight plan finalization module 107, and the guidance control module 108 correspond to the flight plan generation portion 110, the flight plan finalization portion 120, and the guidance control portion 130 illustrated in FIG. 2, respectively. The processing device 101 can provide the functions of the flight plan generation portion 110, the flight plan finalization portion 120, and the guidance control portion 130 by executing the operation management program 105.

The terminal device group 140 represents a computer operated by a user. The terminal device group 140, according to the present embodiment, is composed of multiple terminal devices, but may be composed of a single terminal device.

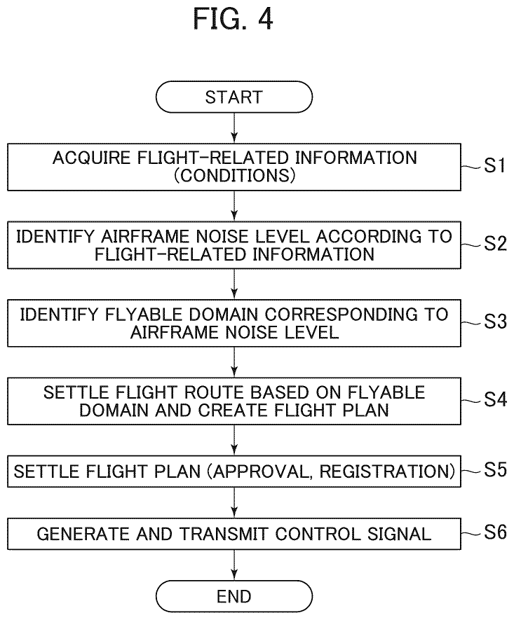

FIG. 4 is a flowchart illustrating the process performed by the operation management device illustrated in FIG. 2.

At Step S1, the operation management device 100 acquires the flight-related information about the flight vehicle 200. The flight-related information represents a prerequisite to generate the flight plan 330 for the flight vehicle 200. The flight-related information includes information about the flight vehicle 200, such as the departure place, scheduled departure time, arrival place, and scheduled arrival time. The flight-related information also includes the remaining amount of fuel or battery used for the flight vehicle 200, the weight of the flight vehicle 200, and meteorological information, for example. The operation management device 100 may acquire the flight-related information by receiving part of the flight-related information input by the user to the terminal device group 140 or by reading part of the previously stored flight-related information.

At Step S2, the flight plan generation portion 110 of the operation management device 100 identifies an airframe noise level corresponding to the flight-related information acquired at Step S1 by using the airframe noise level information 320. Specifically, the flight plan generation portion 110 searches for the airframe noise level information 320 corresponding to the acquired flight-related information, and identifies the airframe noise level indicated by the airframe noise level information 320.

In Step S3, the flight plan generation portion 110 identifies the flyable domain corresponding to the airframe noise level identified in Step S2 by using the flyable domain information 310. Specifically, the flight plan generation portion 110 identifies the location conditions of voxels conforming to the identified airframe noise level. The flight plan generation portion 110 identifies the restriction level of voxels corresponding to the identified location condition by using the flyable domain information 310. The flight plan generation portion 110 extracts the voxels forming the flyable domain by considering the identified restriction level.

When extracting the voxels composing the flyable domain, the flight plan generation portion 110 settles an isolation distance for the flight vehicle 200 from a site adjacent to the air area based on the airframe noise level of the flight vehicle 200. Then, the flight plan generation portion 110 extracts the voxels composing the flyable domain based on the settled isolation distance. The isolation distance will be described in detail later in a fifth embodiment.

In Step S4, the flight plan generation portion 110 combines the voxels or the flyable domains, extracted in Step S3, to settle the flight route. Specifically, the flight plan generation portion 110 identifies the extracted voxels, in each management air area, that are continuous or adjacent from the departure place to the arrival place included in the flight-related information, and identifies the route, formed by combining the identified voxels, as a flight route candidate. If there are the multiple flight route candidates, the flight plan generation portion 110 evaluates these flight route candidates to settle the flight route. When evaluating the flight route candidates, the flight plan generation portion 110 can use an evaluation condition such as a short distance, a low restriction level, or a combination of these. Consequently, the flight plan generation portion 110 can settle the flight route from the departure place to the arrival place.

If there is no flight route candidate, the flight plan generation portion 110 outputs an infeasible flight to the communication device 102 and allows it to transmit this situation to the terminal device group 140. The flight plan generation portion 110 may output additional information prompting the user to create a flight plan to the communication device 102 and allows it to transmit the information to the terminal device group 140. The flight plan generation portion 110 thereafter terminates the process illustrated in FIG. 4.

When the flight route is settled, the flight plan generation portion 110 generates the flight plan 330 by performing a process such as adding identification information of the flight vehicle 200 and the scheduled time of passage to the voxels composing the settled flight route.

At Step S5, the flight plan finalization portion 120 of the operation management device 100 outputs the flight plan 330 generated at Step S4 to the communication device 102, and allows it to transmit the flight plan 330 to the terminal device group 140. The flight plan finalization portion 120 determines that the flight plan 330 is approved when the terminal device group 140 accepts the approval input from the user and the communication device 102 receives the approval input. The flight plan finalization portion 120 registers the approved flight plan 330 to the auxiliary storage device 104. The flight plan finalization portion 120 thereby finalizes the flight plan 330.

At Step S6, the guidance control portion 130 of the operation management device 100 generates a control signal corresponding to the flight plan 330 finalized at Step S5. The guidance control portion 130 outputs the generated control signal to the communication device 102 and allows it to transmit the control signal to the flight vehicle 200. The flight vehicle 200 will fly according to the finalized flight plan 330. At this time, the guidance control portion 130 outputs the control signal so that the flight vehicle 200 flies through each voxel at the scheduled time of passage included in the flight plan 330. The guidance control portion 130 thereafter terminates the process illustrated in FIG. 4.

In the process illustrated in FIG. 4, the operation management device 100 may allow the flight plan generation portion 110 to settle or generate the multiple flight routes or multiple flight plans 330 and allow the flight plan finalization portion 120 or the guidance control portion 130 to select at least one of these flight routes or plans appropriate for the flight vehicle 200. When making this selection, the flight plan finalization portion 120 or the guidance control portion 130 may use the technique of evaluating the flight route candidates described at Step S4. If the flight plan finalization portion 120 or the guidance control portion 130 cannot select at least one of these flight routes or plans appropriate for the flight vehicle 200, the flight plan generation portion 110 may settle or generate a new flight route or the flight plan 330. Alternatively, the flight plan generation portion 110 may settle or generate the flight route or the flight plan 330 each time the flight vehicle 200 flies.

As above, the operation management device 100 settles the flight route of the flight vehicle 200 and performs operation management on the flight vehicle 200. The operation management device 100 is preliminarily assigned with the airframe noise level information 320 which represents the airframe noise level, the level of the noise emitted from the flight vehicle 200, according to each flight vehicle 200. The operation management device 100 identifies the flyable domain indicating the air area where the flight vehicle 200 can fly according to the airframe noise level of the flight vehicle 200 for which the flight route is to be settled. The operation management device 100 settles the flight route of the flight vehicle 200 based on the identified flyable domain.

Consequently, the operation management device 100 can settle the flight route by identifying the flyable domain free from the noise problem caused by the flight vehicle 200 before calculating the flight route candidates for the flight vehicle 200 for which the flight route is to be settled. Then, the operation management device 100 can limit the number of voxels or corridors to be calculated when settling the flight route free from the noise problem. Therefore, the operation management device 100 can settle the flight route free from the noise problem by using a small amount of calculation.

The operation management device 100 measures the airframe noise level by using the frequency weighting characteristic considering human hearing.

Consequently, the operation management device 100 can accurately identify the flyable domain free from a noise problem caused by the flight vehicle 200 for which the flight route is to be settled. Therefore, the operation management device 100 can settle the flight route free from the noise problem accurately and by using a small amount of calculation.

### Second Embodiment

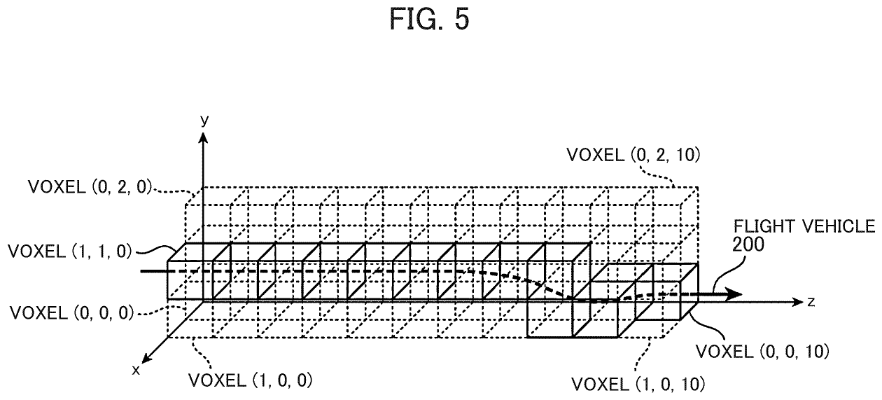

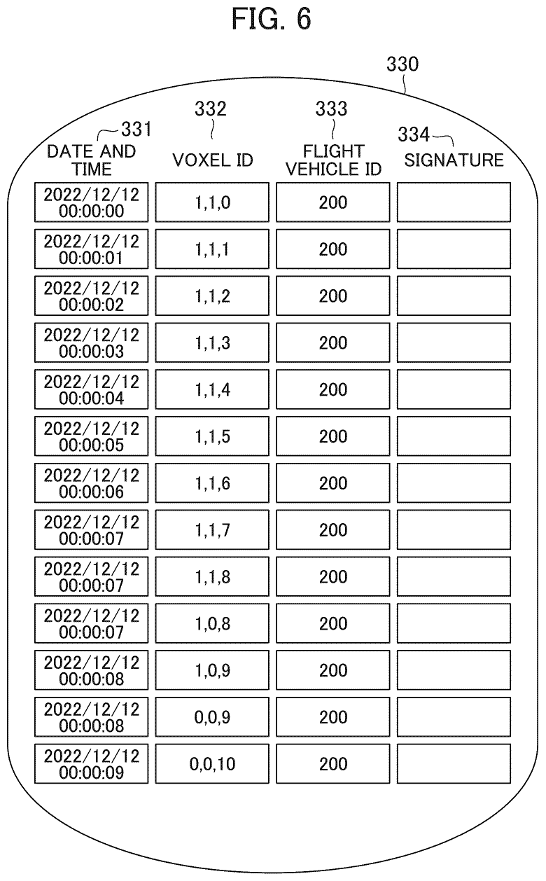

A second embodiment explains the flight plan. FIG. 5 is a diagram illustrating an example of dividing the management air area by using the voxels. FIG. 6 is a diagram illustrating the flight plan generated based on the voxels illustrated in FIG. 5.

As illustrated in FIG. 5, an air area managed by the operation management device 100 is divided into the multiple voxels. The flight route can be represented as a set of voxels occupied by the flight vehicle 200 at the corresponding time. In this case, the flight plan 330 is also represented as a set of voxels occupied by the flight vehicle 200 at the corresponding time, as illustrated in FIG. 6. Specifically, the flight plan 330 is represented as a set of date and time 331, voxel ID 332, flight vehicle ID 333, and authentication signature 334. Namely, the flight plan shows that flight vehicle ID 333 occupies the voxel ID 332 at the date and the time 331. The voxel ID is expressed as the (X, Y, Z) coordinates of the voxel.

The examples in FIGS. 5 and 6 show that flight vehicle 200 occupies voxels (1, 1, 0), (1, 1, 1), (1, 1, 2), (1, 1, 3), (1, 1, 4), (1, 1, 5), (1, 1, 6), (1, 1, 7), (1, 1, 8), (1, 0, 8), (1, 0, 9), (0, 0, 9), and (0, 0, 10) as time advances from 00:00:00 on Dec. 12, 2022 to 00:00:09 on Dec. 12, 2022. At 00:00:07 on Dec. 12, 2022, the flight vehicle 200 occupies three adjacent voxels (1, 1, 7), (1, 1, 8), and (1, 0, 8). Similarly, at 00:00:08 on Dec. 12, 2022, the flight vehicle 200 occupies two adjacent voxels (1, 0, 9) and (0, 0, 9).

To avoid collisions between the flight vehicles 200, the flight vehicle 200 needs to exclusively occupy the voxels in terms of space and time. Namely, the date and the time 331 and the voxel ID 332 need to be assigned to each flight vehicle 200 without overlaps. Thus, the flight plan generation portion 110 settles the flight route and generates the flight plan 330 so that the date and the time 331 and the voxel ID 332 are not assigned to multiple flight vehicle IDs 333 duplicately.

The flight plan finalization portion 120 confirms that the date and the time 331 and the voxel ID 332 are not duplicated (not assigned to multiple flight vehicle IDs 333) each time the flight plan 330 is generated or updated, and writes the authentication signature 334 as evidence of the confirmation. The authentication signature 334 may use a predetermined code. Alternatively, the authentication signature 334 may use a sum check on information such as the date and the time 331, the voxel ID 332, and the flight vehicle ID 333, or a calculated value of a predetermined polynomial based on the information. It is possible to determine whether the flight plan 330 is valid by determining whether the authentication signature 334 matches an expected authentication value supplied from the information, such as the date and the time 331, the voxel ID 332, and the flight vehicle ID 333.

The guidance control portion 130 controls and guides the flight vehicle 200 based on the flight plan 330. Specifically, the guidance control portion 130 supplies a control signal to the flight vehicle 200 according to the date and the time 331, the voxel ID 332, and the flight vehicle ID 333 included in the flight plan 330. Specifically, the guidance control portion 130 supplies the control signal to the flight vehicle 200 according to the date and the time 331, the voxel ID 332, and the flight vehicle ID 333 included in the flight plan 330.

### Third Embodiment

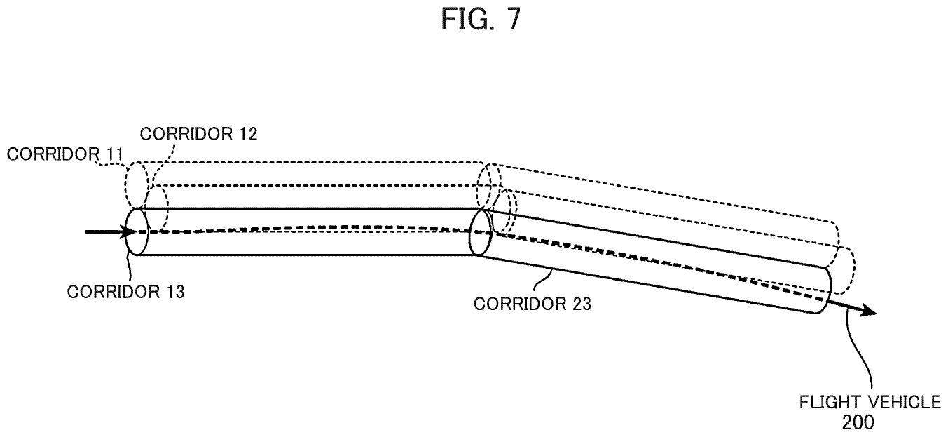

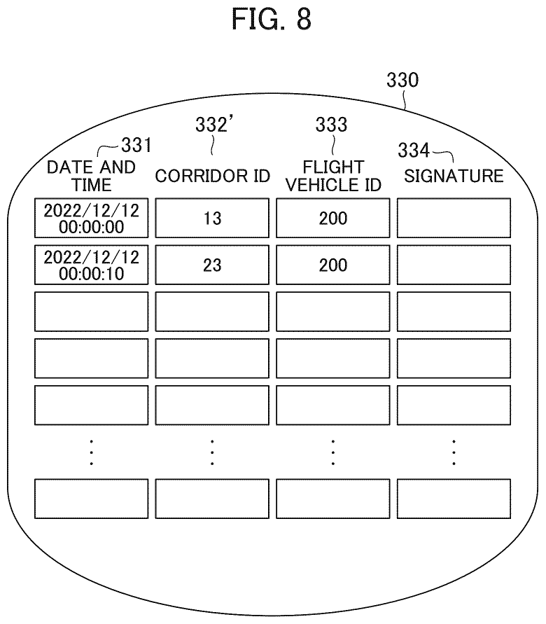

A third embodiment explains the division of a management air area by using corridors. FIG. 7 is a diagram explaining an example of dividing an air area by using the corridors. FIG. 8 is a diagram illustrating a flight plan generated based on the corridors illustrated in FIG. 7.

The air area managed by the operation management device 100 may be divided into the multiple corridors as illustrated in FIG. 7. The flight route can be represented as a set of corridors occupied by the flight vehicle 200 at the corresponding time. In this case, the flight plan 330 is also expressed as a set of corridors occupied by the flight vehicle 200 at the corresponding time, as illustrated in FIG. 8. Specifically, the flight plan 330 is represented as a set of the date and the time 331, corridor ID 332′, the flight vehicle ID 333, and the authentication signature 334. Namely, the flight plan shows that the flight vehicle ID 333 occupies the corridor ID 332′ at the date and the time 331.

The examples of FIG. 7 and FIG. 8 show that the flight vehicle 200 occupies a corridor 13 at 00:00:00 on Dec. 12, 2022, and a corridor 23 at 00:00:10 on Dec. 12, 2022. Similar to the second embodiment, the flight plan generation portion 110 and flight plan finalization portion 120 generate and finalize the flight plan 330. Similar to the second embodiment, the guidance control portion 130 guides and controls the flight vehicle 200.

It is also possible to represent air areas near airports or the flight route branching points by the voxels as illustrated in FIG. 5, and represent a route connecting them by using the corridors as illustrated in FIG. 7. In this case, it may be favorable to share the field for the voxel ID 332 and the corridor ID 332′ and add an identifier to identify whether the ID indicates the voxel or the corridor. For example, the field for the voxel ID 332 is prefixed with identifier “V,” and the field for the corridor ID 332′ is prefixed with identifier “C.”

### Fourth Embodiment

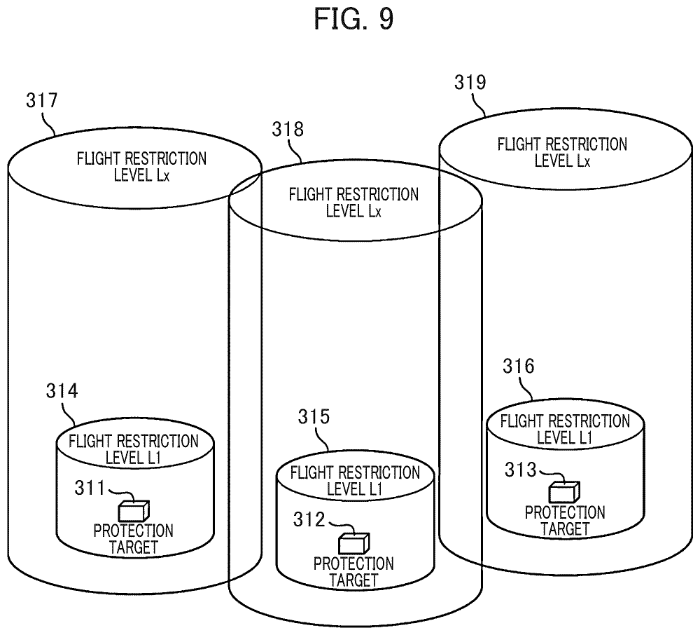

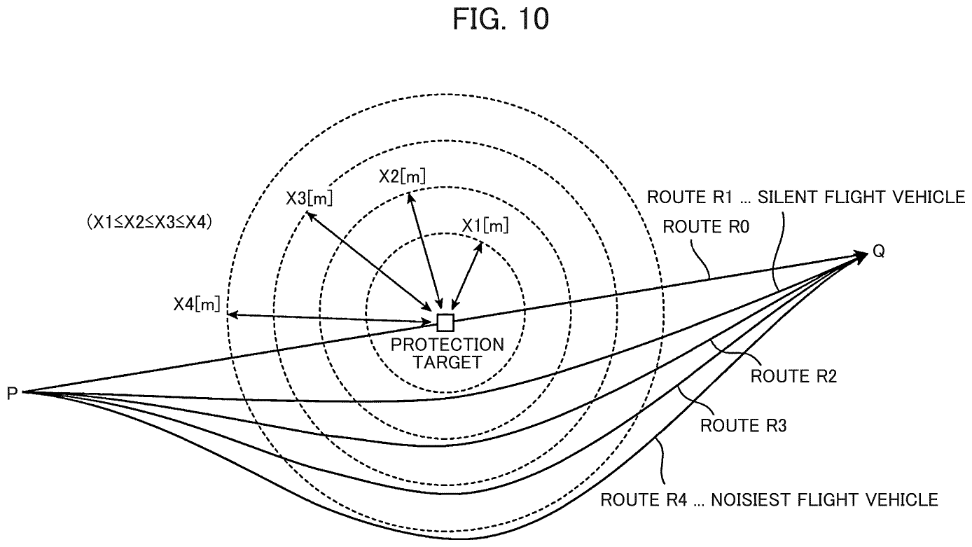

A fourth embodiment explains the flyable domain information. FIG. 9 is a diagram illustrating the flyable domain information. FIG. 10 is a diagram illustrating flight route settlement based on the flyable domain information.

The flyable domain information 310 represents the flyable domain by using the coordinates of a unit air area (voxel or corridor) or the unit air area ID (voxel ID or corridor ID) on the air area map. The flyable domain information 310 according to the present embodiment includes the coordinates of protection targets 311, 312, and 313 such as facilities to be protected from noise or important facilities, and the coordinates of level-L1 flight restriction domains 314, 315, and 316, and level-Lx flight restriction domains 317, 318, and 319 corresponding to the protection targets 311, 312, and 313, respectively.

In the above-described example, the flyable domain information 310 previously specifies the flight restriction domains on the air area map. Meanwhile, the flyable domain information 310 may include the coordinates of the protection targets on the air area map and the restriction levels to restrict the flight of the flight vehicle 200. The flight plan generation portion 110 may specify the restriction domains (coordinates) corresponding to the restriction levels based on the flyable domain information 310.

FIG. 10 shows an example of settling the flight routes based on the flyable domain information 310. The flight route from point P to point Q in an air area must be separated from the protection target on the route by a predetermined distance (X1 through X4 [m], where X1≤X2≤X3≤X4) according to the airframe noise levels of the flight vehicle 200. Therefore, the flight routes from point P to point Q are settled as route R4, route R3, route R2, and route R1 in descending order of the airframe noise levels of the flight vehicle 200. The flight vehicle 200 satisfying a lower airframe attribute level can fly a shorter flight route from point P to point Q. Route R0, settled as the flight route, to fly over an important facility (including flights for maintenance and inspection of the important facility), for example, is limited to the flight vehicle 200 that ensures an extremely low airframe noise level, low failure rate, and high security level.

### Fifth Embodiment

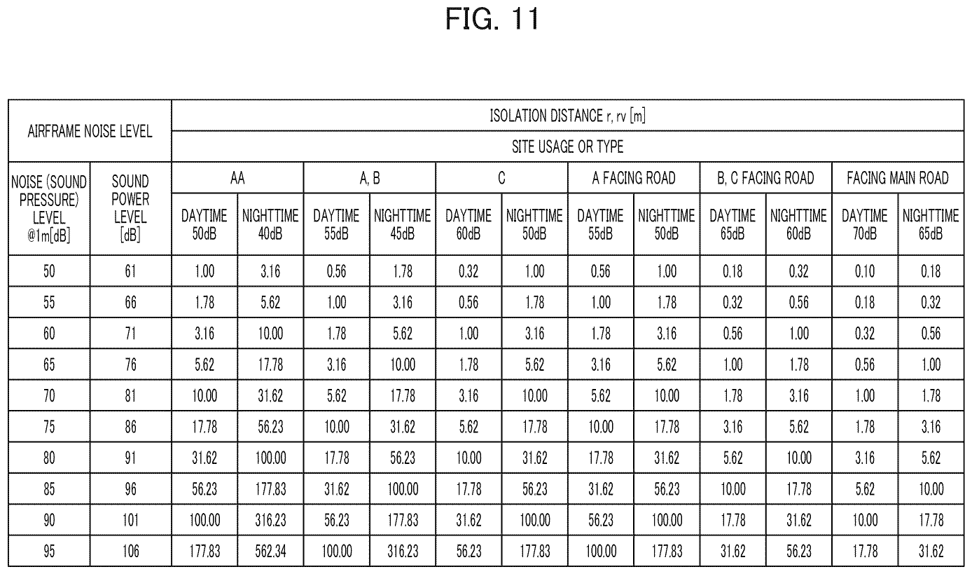

A fifth embodiment explains the airframe noise level and the isolation distance. FIG. 11 is a diagram illustrating a table defining the relationship between the airframe noise level and an isolation distance.

The flyable domain indicated by the flyable domain information 310 is set by the isolation distance of the flight vehicle 200 from a site adjacent to the air area. The isolation distance indicates a distance maintained to isolate the flight vehicle 200 from such site to satisfy environmental standards related to noise regulations. According to the Ministry of the Environment of Japan (https://www.env.go.jp/kijun/otol-1.html), environmental standards related to the noise regulations are stipulated based on the site usage or type and the time window (daytime or nighttime).

FIG. 11 illustrates the table that defines the relationship between the airframe noise level of the flight vehicle 200 and the isolation distance from the site for the flight vehicle 200. FIG. 11 sets the isolation distances by assuming the flight vehicle 200 to be a point sound source that emits non-directional noise. As illustrated in FIG. 11, the isolation distance is set to different values depending on the uses or types of sites adjacent to the air area. The isolation distance is set to different values depending on the flight time window (daytime or nighttime) of the flight vehicle 200.

In FIG. 11, “AA” listed as the site usage or type indicates a site in an area where silence is particularly required, such as an area where medical facilities or social welfare facilities are built concentratively. The environmental standards related to the noise regulations for sites classified as “AA” are stipulated as 50 dB or less during the daytime and 40 dB or less during the nighttime, for example. In FIG. 11, “A” listed as the site usage or type indicates the site in an area used exclusively for residential purposes. The environmental standards related to the noise regulations for sites classified as “A” are stipulated as 55 dB or less during the daytime and 45 dB or less during the nighttime, for example. In FIG. 11, “B” listed as the site usage or type indicates the site in an area used mainly for residential purposes. The environmental standards related to the noise regulations for sites classified as “B” are stipulated as 55 dB or less during the daytime and 45 dB or less during the nighttime, for example. In FIG. 11, “C” listed as the site usage or type indicates the site in an area used for commercial or industrial purposes in addition to a significant number of residences. The environmental standards related to the noise regulations for sites classified as “C” are stipulated as 60 dB or less during the daytime and 50 dB or less during the nighttime, for example. In FIG. 11, “A facing road” listed as the site usage or type indicates the site in an area facing a road with two or more lanes in the site “A.” The environmental standards related to the noise regulations for sites classified as “A facing road” are stipulated as 60 dB or less during the daytime and 55 dB or less during the nighttime, for example. In FIG. 11, “B facing road” listed as the site usage or type indicates the site in an area facing the road with two or more lanes in the site “B.” The environmental standards related to the noise regulations for sites classified as “B facing road” are stipulated as 65 dB or less during the daytime and 60 dB or less during the nighttime, for example. In FIG. 11, “C facing road” listed as the site usage or type indicates the site in an area facing the road with at least one lane in the site “C.” The environmental standards related to the noise regulations for sites classified as “C facing road” are stipulated as 65 dB or less during the daytime and 60 dB or less during the nighttime, for example. In FIG. 11, “facing main road” listed as the site usage or type indicates the site in an area facing the road for arterial traffic. The environmental standards related to the noise regulations for sites classified as “facing main road” are stipulated as 70 dB or less during the daytime and 65 dB or less during the nighttime, for example.

Generally, the noise (sound pressure) level of the flight vehicle 200 is defined as Lr1 [dB] while distanced by r1 [m]. Given that r2 [m] denotes the distance from the noise to the protection target and Lr2 [dB] denotes the noise level to be regulated. Then, Equation (1) below holds.

$$Lr 1 - Lr 2 = 20 {log}_{10} ( r 2 / r 1 ) \qquad ( 1 )$$

Divide both sides of Equation (1) by 20. Then, Equation (2) below holds.

$$( Lr 1 - Lr 2 ) / 20 = {log}_{10} ( r 2 / r 1 ) \qquad ( 2 )$$

Express both sides of Equation (2) as a power of 10. Then, Equation (3) below holds.

$$1 {0}^{\{ ( Lr 1 - Lr 2 ) / 20 \}} = ( r 2 / r 1 ) \qquad ( 3 )$$

Multiply both sides of Equation (3) by r1. Then, Equation (4) below is acquired.

$$r 2 = r 1 \times {10}^{\{ ( Lr 1 - Lr 2 ) / 20 \}} \qquad ( 4 )$$

The table illustrated in FIG. 11 can be generated based on Equation (4). If the noise is non-directional, the acoustic power level is calculated by applying an area integral to the noise (sound pressure) level over a closed surface. Accordingly, the multiplication of 4π (r1)², where r1=1 [m], results in 10 log₁₀ (4π)=10.99≈11 [dB]. Then, the acoustic power level illustrated in FIG. 11 can be calculated by adding 11 [dB] to the noise (sound pressure) level.

The operation management device 100 preliminarily stores the table illustrated in FIG. 11. The flight plan generation portion 110 of the operation management device 100 uses the table illustrated in FIG. 11 to settle an isolation distance corresponding to the airframe noise level of the flight vehicle 200. The flight plan generation portion 110 extracts the voxels as the flyable domain based on the identified isolation distance, and combines the extracted voxels to settle the flight route.

The operation management device 100 preliminarily assigns each airframe noise level with an isolation distance, namely, the distance kept to isolate the flight vehicle 200 from sites adjacent to the air area. The operation management device 100 identifies the flyable domain for the flight vehicle 200 based on the isolation distance corresponding to the airframe noise level of the flight vehicle 200 for which the flight route is to be settled.

Consequently, the operation management device 100 can identify the flyable domain free from the noise problem of the flight vehicle 200 for which the flight route is to be settled, accurately and by using a smaller amount of calculation. Consequently, the operation management device 100 can settle the flight route free from the noise problem accurately and by using a smaller amount of calculation.

The operation management device 100 sets the isolation distance to different values according to the site usage or type.

Consequently, the operation management device 100 can more accurately identify the flyable domain free from the noise problem of the flight vehicle 200 for which the flight route is to be settled, according to the usage or type of the adjacent site. Therefore, the operation management device 100 can settle the flight route free from the noise problem more accurately and by using a small amount of calculation.

The operation management device 100 also sets the isolation distance to different values according to the flight time window of the flight vehicle 200

Consequently, the operation management device 100 can more accurately identify the flyable domain free from the noise problem of the flight vehicle 200 for which the flight route is to be settled, according to the flight time window. Consequently, the operation management device 100 can settle the flight route free from the noise problem more accurately and by using a small amount of calculation.

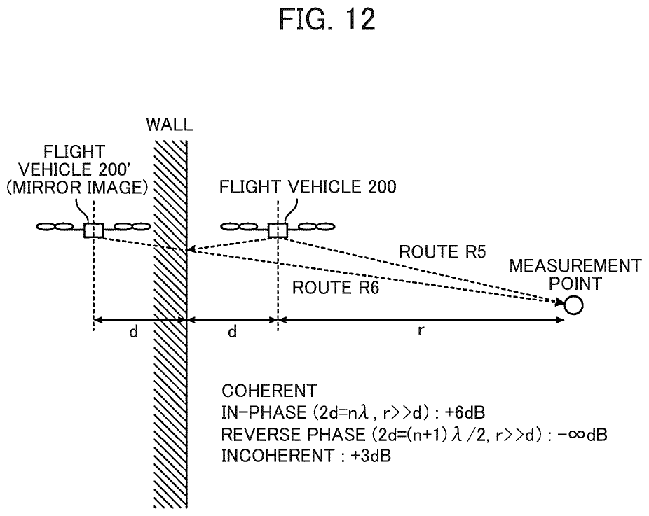

FIG. 12 is a diagram illustrating an isolation distance, considering the presence or absence of a wall adjacent to flight vehicles.

FIG. 12 illustrates an example of measuring the noise (sound pressure) level at a measurement point isolated from the flight vehicle 200 by distance r while the flight vehicle 200 is flying at a position isolated from the wall in the horizontal direction by distance d, under the condition of r>>d. The noise emitted from flight vehicle 200 propagates to the measurement point as indicated by path R5, is also reflected off on the wall as indicated by path R6, and then propagates to the measurement point. Suppose the wall reflection rate of the noise is set to 1.0 at worst, and there is no phase inversion due to reflection on the wall.

In the example of FIG. 12, the noise emitted from flight vehicle 200 may be an incoherent sound wave such as white noise or pink noise. In this case, the noise (sound pressure) level at the measurement point is +3 dB higher than in the case where there is no wall reflection. This is because the acoustic energy (sound power) per unit time of the noise is concentrated on the side where there is no wall.

Suppose the noise emitted from the flight vehicle 200 is a coherent sound wave such as a sine wave, and the sound wave propagating directly to the measurement point and the sound wave reflected off on the wall are in phase (2d=nλ). Then, the noise (sound pressure) level at the measurement point is +6 dB higher than in the case where there is no wall reflection. Suppose the sound wave propagating directly to the measurement point and the sound wave reflected off on the wall conform to the reverse phase (2d=(n+1) λ/2). Then, the noise (sound pressure) level at the measurement point is ∞ dB lower (−∞ dB higher) than in the case where there is no wall reflection. Suppose a hemisphere including some unevenness depending on the directions at the side where there is no wall. Then, the acoustic power level per unit time of the noise integrated over the hemisphere is +3 dB higher, equal to the case of incoherent sound waves.

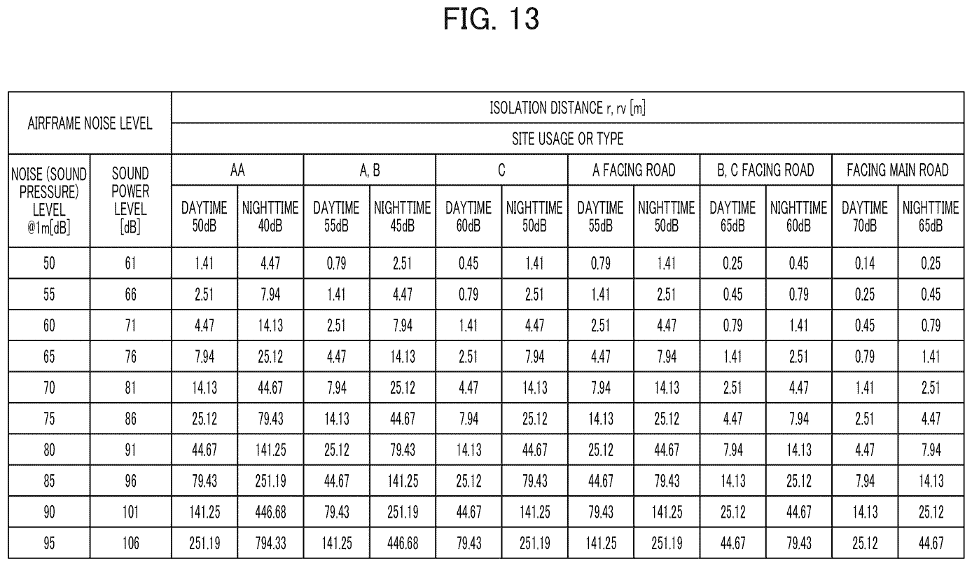

FIG. 13 illustrates a table that defines the relationship between the airframe noise level and the isolation distance when there is a wall close to the flight vehicle in the horizontal direction of the flight vehicle.

The table in FIG. 13 illustrates the relationship between the airframe noise level and the isolation distance when the noise emitted from the flight vehicle 200 reflects off on the wall as illustrated in FIG. 12, and the noise level increases by +3 dB. FIG. 13 corresponds to FIG. 11.

Define r1 [m], r2 [m], Lr1 [dB], and Lr2 [dB] similar to FIG. 11. Then, Equation (5) below holds.

$$Lr 1 + 3 - Lr 2 = 20 {log}_{10} ( r 2 / r 1 ) \qquad ( 5 )$$

Divide both sides of Equation (5) by 20. Then, Equation (6) below holds.

$$( Lr 1 + 3 - Lr 2 ) / 20 = {log}_{10} ( r 2 / r 1 ) \qquad ( 6 )$$

Express both sides of Equation (6) as a power of 10. Then, Equation (7) below holds.

$${10}^{\{ ( Lr 1 + 3 - Lr 2 ) / 20 \}} = ( r 2 / r 1 ) \qquad ( 7 )$$

Multiply both sides of Equation (7) by r1. Then, Equation (8) below is acquired.

$$r 2 = r 1 \times {10}^{\{ ( Lr 1 + 3 - Lr 2 ) / 20 \}} \qquad ( 8 )$$

The table illustrated in FIG. 13 can be generated based on Equation (8). Similar to FIG. 11, the acoustic power level illustrated in FIG. 13 can be calculated by adding 11 [dB] to the noise (sound pressure) level.

The operation management device 100 preliminarily stores the table illustrated in FIG. 13 as well as the table illustrated in FIG. 11. The flight plan generation portion 110 uses the table illustrated in FIG. 11 or 13 to settle the isolation distance corresponding to the airframe noise level of the flight vehicle 200.

Namely, the operation management device 100 sets the isolation distance to different values depending on whether there is a wall adjacent to the flight vehicle 200.

Consequently, the operation management device 100 can more accurately identify the flyable domain free from the noise problem of the flight vehicle 200 for which the flight route is to be settled, depending on whether there is the wall adjacent to the flight vehicle 200. Consequently, the operation management device 100 can settle the flight route free from the noise problem more accurately and by using a small amount of calculation.

The operation management device 100 can settle the isolation distance, considering the addition of the noise levels even when the multiple flight vehicles 200 fly closely at the same time. The isolation distances illustrated in FIG. 13 can be ensured when two flight vehicles 200 showing the same noise level fly closely at the same time, for example. In this case, the operation management device 100 can settle the isolation distance corresponding to the airframe noise level of the flight vehicles 200 by using the table illustrated in FIG. 13. If the isolation distances illustrated in FIG. 13 cannot be ensured, the operation management device 100 generates the flight plan 330 so that the multiple flight vehicles 200 fly at intervals from each other so as not to fly closely.

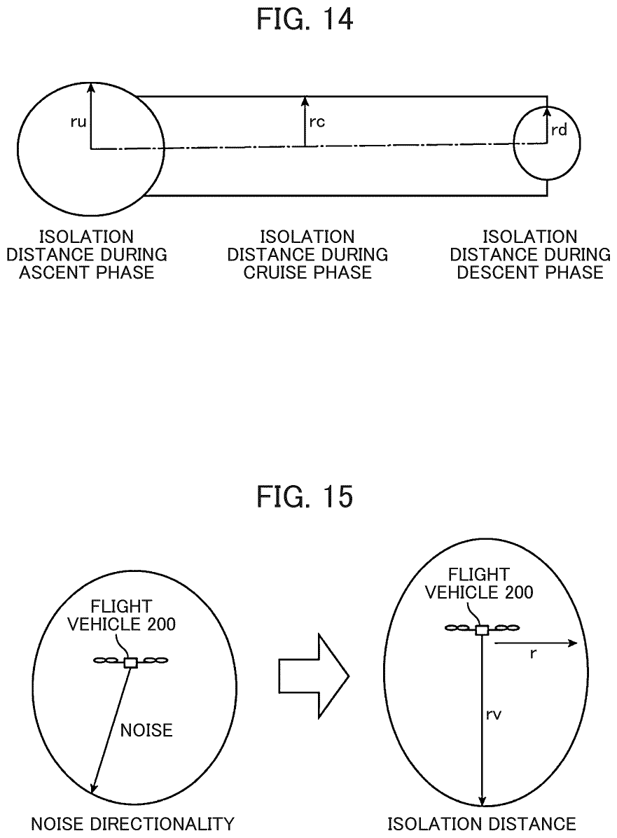

FIG. 14 is a diagram illustrating the isolation distances, considering the flight phases of the flight vehicle.

The output of the flight vehicle 200 (blade rotating speed of the flight vehicle 200) varies with flight phases (ascent, cruise, and descent) of the flight vehicle 200. The noise (sound pressure) level emitted from the flight vehicle 200 varies with the flight phases of the flight vehicle 200. Then, the operation management device 100 sets the isolation distance to different values depending on the flight phases of the flight vehicle 200. As illustrated in FIG. 14, for example, isolation distance ru in the ascent phase is set to be larger than isolation distance rc in the cruise phase. Isolation distance rd in the descent phase is set to be smaller than the isolation distance rc in the cruise phase.

Consequently, the operation management device 100 can more accurately identify the flyable domain free from the noise problem of the flight vehicle 200 for which the flight route is to be settled, depending on the flight phases of the flight vehicle 200. Therefore, the operation management device 100 can settle the flight route free from the noise problem more accurately and by using a small amount of calculation.

The output of the flight vehicle 200 (blade rotating speed of the flight vehicle 200) varies with the total weight of the flight vehicle 200. The noise (sound pressure) level emitted from the flight vehicle 200 varies with the total weight of the flight vehicle 200. Then, the operation management device 100 sets the isolation distance to different values depending on the total weight of the flight vehicle 200. For example, the isolation distance is set to be larger for the flight vehicle 200 having a large total weight than for the flight vehicle 200 having a small total weight.

Consequently, the operation management device 100 can more accurately identify the flyable domain free from the noise problem of the flight vehicle 200 for which the flight route is to be settled, depending on the total weight of the flight vehicle 200. Therefore, the operation management device 100 can settle the flight route free from the noise problem more accurately and by using a small amount of calculation.

FIG. 15 is a diagram illustrating the isolation distance, considering the directivity of the noise emitted from the flight vehicle.

There may be the case where the noise emitted from the flight vehicle 200 is propagated directionally, not isotropically. The operation management device 100 sets the isolation distance to different values depending on the directivity of the noise emitted from the flight vehicle 200. As illustrated in FIG. 15, for example, there may be the case where the noise emitted from the flight vehicle 200 shows directivity in the downward direction of the flight vehicle 200 and is more likely to propagate downward than horizontally and upwardly from the flight vehicle 200. In this case, isolation distance rv in the downward direction of the flight vehicle 200 is set to be greater than isolation distance r in the horizontal direction.

Consequently, the operation management device 100 can more accurately identify the flyable domain free from the noise problem of the flight vehicle 200 for which the flight route is to be settled, depending on the noise directivity. Therefore, the operation management device 100 can settle the flight route free from the noise problem more accurately and by using a small amount of calculation.

When the noise emitted from the flight vehicle 200 is directional, the noise (sound pressure) level is set to different values depending on the directions. However, the acoustic power level is defined as a value resulting from applying an area integral to the acoustic intensity on a closed surface surrounding the sound source, has no concept of directivity, and is therefore set to a constant value. This is because the acoustic power level is an index for evaluating the overall acoustic power of the noise emitted from the sound source, regardless of directivity. It may be favorable to use the noise (sound pressure) level rather than the acoustic power level when setting the isolation distance to different values depending on the noise directivity.

It is also possible to surround a propeller of the flight vehicle 200 with a duct or emit sound waves in a phase opposite to the noise from a speaker, thereby providing the flight vehicle 200 with an ANC (Active Noise Cancelling) function and controlling the noise directivity. ANC seems to be able to cancel out and reduce noise. However, the flight vehicle 200 installed with the ANC function adversely increases the noise (sound pressure) level in the direction corresponding to the same phases. The acoustic power level increases by the amount of acoustic energy (acoustic power) per unit time from the speaker. ANC should be considered as a means to control the noise directivity, not a means to reduce the noise.

### Sixth Embodiment

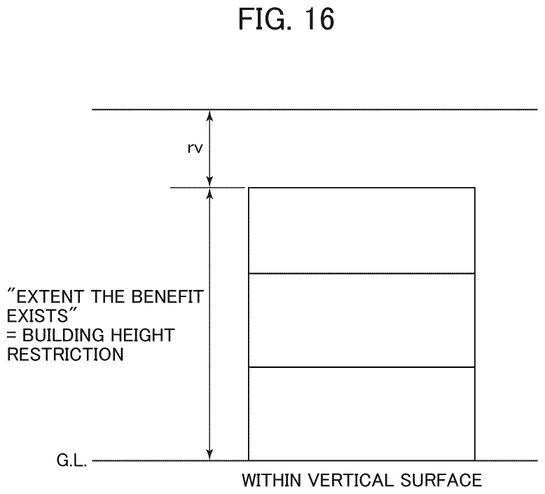

A sixth embodiment explains the flight vehicle flying over the site. FIG. 16 is a diagram illustrating the restriction on flight altitudes of the flight vehicle.

For example, the Japanese government considers the relationship between the flight of unmanned aerial vehicles and land ownership as seen from the following URL. http://www.kantei.go.jp/jp/singi/kogatamujinki/kanminkyougi_dai16/betten4.pdf

Thus, the Japanese Civil Code stipulates that “Ownership in land extends to above and below the surface of the land, within the limits of laws and regulations.” (Article 207 of the Civil Code). The extent of the space on the land to which ownership extends is generally considered the “extent the benefit exists” of a person who owns the land. Therefore, it is understood that it is not always necessary to acquire the consent of a landowner when an unmanned aerial vehicle flies the sky above the third party's land. In this case, it is difficult to uniformly set a specific range of the landowner's “extent the benefit exists,” which will be determined on a case-by-case basis in light of the particular usage conditions, such as the installation situations of buildings or structures on such land.

For the above reasons, when the flight vehicle 200 flies over the site, it is preferable that the “extent the benefit exists” of such site satisfies the environmental standards related to the noise regulations. As illustrated in FIG. 16, the operation management device 100 limits the flight altitude of the flight vehicle 200 so that the flight vehicle 200 flies the sky above at least the isolation distance rv in the height direction (vertical direction) from the “extent the benefit exists.” When the flight vehicle 200 flies over the site, there rarely exists a wall close to the flight vehicle 200 in the horizontal direction of the flight vehicle 200. In most cases, the flight plan generation portion 110 of the operation management device 100 may use the table illustrated in FIG. 11 to settle the isolation distance corresponding to the airframe noise level of the flight vehicle 200.

A specific range of the “extent the benefit exists” can be considered the range of building height restrictions stipulated in the City Planning Act of Japan, for example. The City Planning Act of Japan stipulates that a building height is restricted to 10 m or 12 m in category 1 or 2 low-rise exclusive residential districts.

For example, suppose the building height is restricted to 10 m at the site, the site usage or type is “AA,” and the noise (sound pressure) level is 75 dB at a distance of 1 m away from the flight vehicle 200. In this case, the table in FIG. 11 shows that the isolation distance rv is 17.78 m during the daytime and 56.23 m during the nighttime. Therefore, the flight altitude of the flight vehicle 200 flying over the site is limited to 27.78 m or more during the daytime and 66.23 m or more during the nighttime. Namely, the flight plan generation portion 110 settles the flight route of the flight vehicle 200 flying over the site by identifying the flyable domain from the air area that ensures the flight altitude of 27.78 m or more during the daytime and 66.23 m or more during the nighttime.

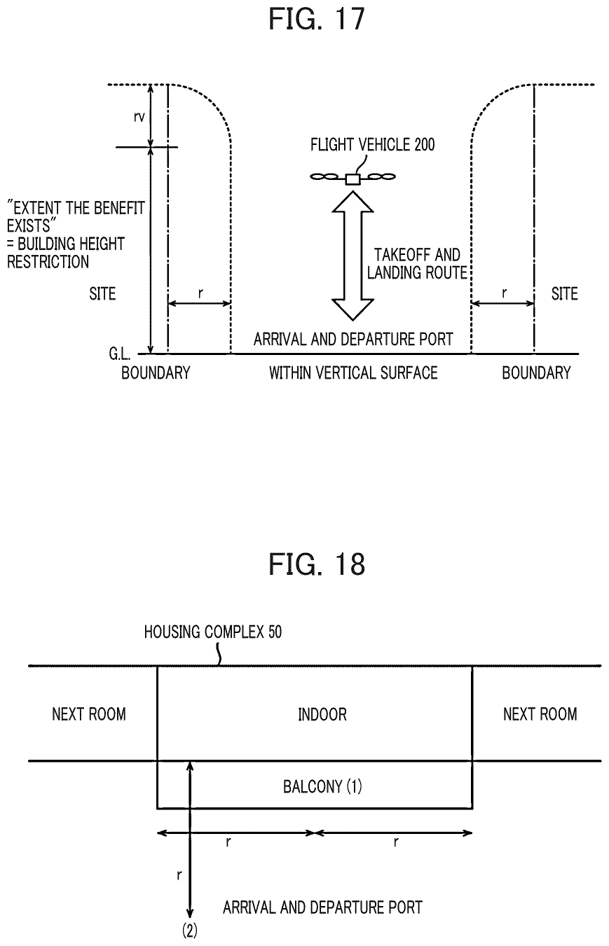

FIG. 17 is a diagram illustrating the installation of an arrival and departure port for the flight vehicle in a location close to the site.

For example, suppose the building height is limited to 10 m, the site usage or type is “A facing road,” and the noise (sound pressure) level is 75 dB at the distance of 1 m from the flight vehicle 200. In this case, the table in FIG. 11 shows that the isolation distance rv is 10.00 m during the daytime and 17.78 m during the nighttime. Therefore, the flight altitude of the flight vehicle 200 flying over the site is limited to 20.00 m or more during the daytime and 27.78 m or more during the nighttime. If there is no wall nearby reflecting noise, the table in FIG. 11 shows that the horizontal isolation distance r is 10.00 m during the daytime and 17.78 m during the nighttime. If there is the wall nearby reflecting noise, the table in FIG. 13 shows that the horizontal isolation distance r is 14.13 m during the daytime and 25.12 m during the nighttime. Therefore, the land where the arrival and departure port is to be placed requires a short side length of 2r or more.

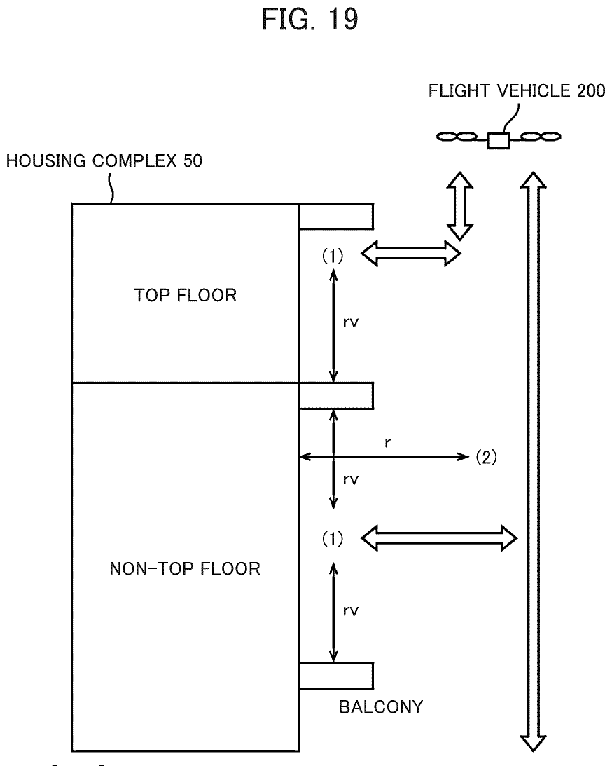

FIG. 18 is a diagram illustrating the installation of the arrival and departure port for the flight vehicle on a balcony of a housing complex. FIG. 19 is a diagram illustrating the installation of the arrival and departure port for the flight vehicle in the housing complex.

For example, suppose the usage or type of the site where a housing complex 50 is built is “facing main road,” the noise (sound pressure) level is 75 dB at the distance of 1 m away from the flight vehicle 200, and there is no wall nearby reflecting noise. In this case, the table in FIG. 11 shows that the isolation distance is 1.78 m during the daytime and 3.16 m during the nighttime. Therefore, the balcony width requires 3.56 m or more for flight during the daytime only, and 6.32 m or more for flight during the nighttime in addition. The distance between the balcony and the floor above or below requires 1.78 m or more for flight during the daytime only, and 3.16 m or more for flight during the nighttime in addition. If the arrival and departure port is to be installed to overhang the balcony, the overhang length requires 1.78 m or more for flight during the daytime only, and 3.16 m or more for flight during the nighttime in addition.

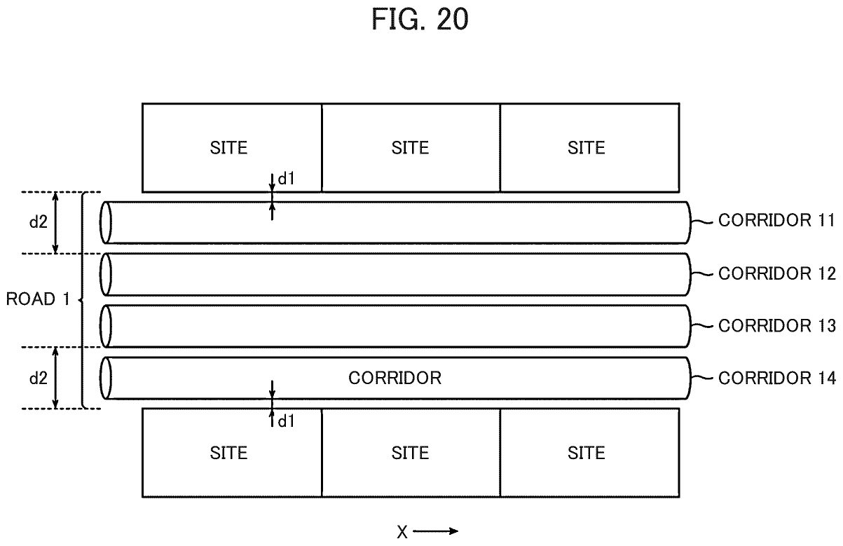

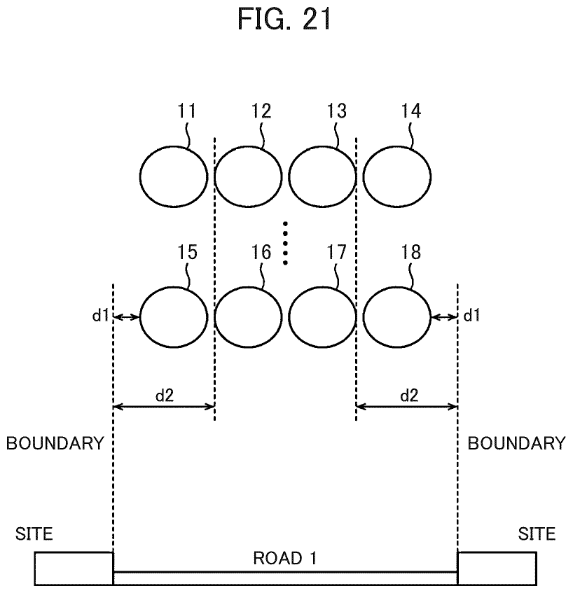

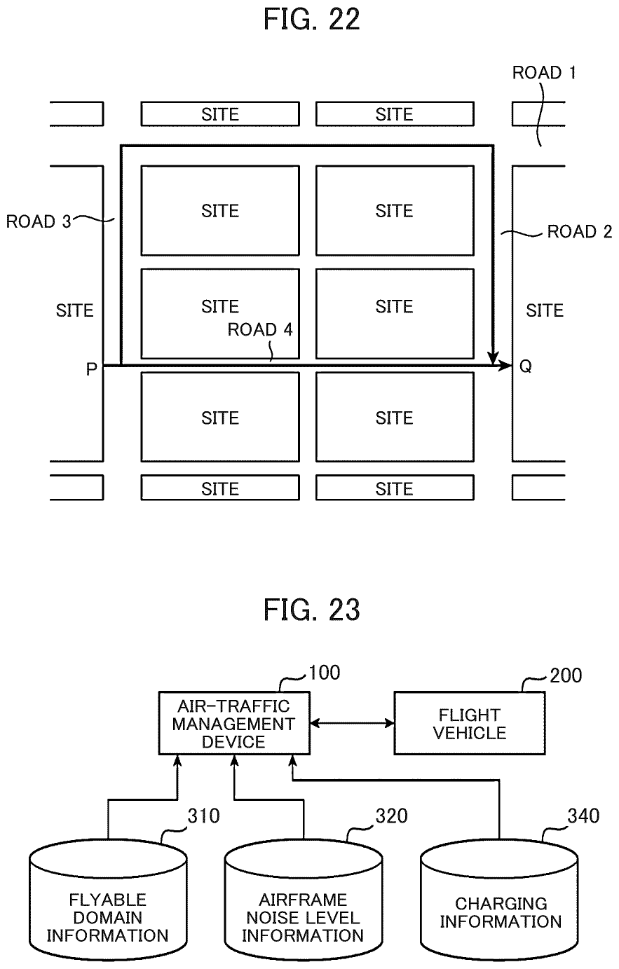

FIG. 20 is a diagram illustrating the flight vehicle flying in an air area above the road. FIG. 21 is a view of FIG. 20 in the X direction. FIG. 22 is a diagram illustrating a difference in the flight routes depending on the airframe noise levels.

In FIGS. 20 and 21, multiple corridors 11 through 18 are set above a road 1. For example, suppose the usage or type of the site adjacent to the road 1 is “facing main road,” the distance d1 from the site to the corridor 11, 14, 15, or 18 is 1.78 m, the distance d2 from the site to the corridor 12, 13, 16, or 17 is 3.16 m, and there are no walls nearby that reflect noise. Out of the corridors 11 through 18, the corridors 11, 14, 15, and 18 are situated close to the site. Out of the corridors 11 through 18, the corridors 12, 13, 16, and 17 are situated farther from the site than the corridors 11, 14, 15, and 18. In this case, according to the table illustrated in FIG. 11, the corridors 11, 14, 15, and 18 enable the aviation of the flight vehicle 200 generating the airframe noise level of 75 dB or less at the distance of 1 m during the daytime. The corridors 12, 13, 16, and 18 enable the aviation of the flight vehicle 200 generating the airframe noise level of 80 dB or less at the distance of 1 m during the daytime. Therefore, the flight vehicles 200 generating the airframe noise levels exceeding the above cannot fly through the corridors 11 through 18 above the road 1. Thus, the flight vehicle 200 must fly at the isolation distance r from the site horizontally. Suppose the width of the corridor is wc. Then, the flight vehicle 200 cannot fly above the road 1 unless the width of the road 1 is W=(2r+wc) or more.

FIG. 22 illustrates the flight routes along which the flight vehicle 200 flies from point P to point Q above any of roads 1 through 4 close to the sites. As above, the road width of W=(2r+wc) or more is required to satisfy the environmental standards related to the noise regulations. The flight vehicle 200, if generating a high airframe noise level, can only fly above the roads 1, 2, and 3, each having the road width of W or more. The flight vehicle 200, if generating a low airframe noise level, can also fly above a road 4 having the road width of less than W. The flight vehicle 200 generating the airframe noise level capable of flying above the road 4 can fly the shortest route from the point P to the point Q.

### Seventh Embodiment

A seventh embodiment explains route pricing to charge aviation along the flight routes. FIG. 23 is a diagram illustrating the operation management device that performs route pricing.

As illustrated in FIG. 23, the operation management device 100 performs operation management and flight control over the flight vehicle 200 based on the flyable domain information 310, the airframe noise level information 320, and charging information 340. Specifically, the operation management device 100 generates the flight plan 330 including the flight routes of the flight vehicle 200 based on the flyable domain information 310, the airframe noise level information 320, and the charging information 340. The operation management device 100 approves and registers the generated flight plan 330 to finalize the flight plan 330. The operation management device 100 guides and controls the flight vehicle 200 to fly according to the finalized flight plan 330.

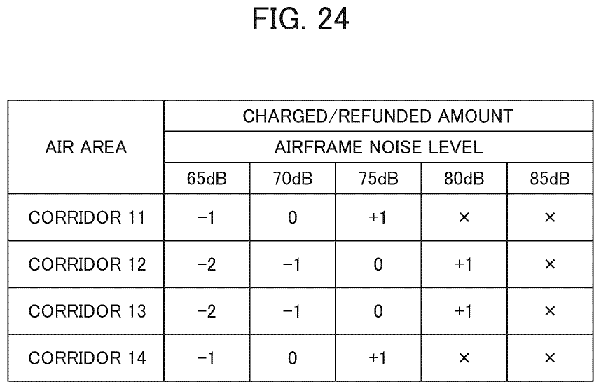

FIG. 24 is a diagram illustrating the charging information illustrated in FIG. 23.

As illustrated in FIG. 24, the charging information 340 defines the correspondence between information on the air area (or the flight route) to be charged or refunded and information on the amount to be charged or refunded for each airframe noise level of the flight vehicle 200. The charging information 340 illustrated in FIG. 24 shows “0” indicating an airframe noise level causing no charge or refund, corresponding to the airframe noise level 5 dB lower than the airframe noise level that satisfies the environmental standards related to the noise regulations. The charging information 340 illustrated in FIG. 24 shows “−1” indicating the airframe noise level causing a refund, corresponding to the airframe noise level 10 dB lower than an airframe noise level that satisfies the environmental standards related to the noise regulations. The charging information 340 illustrated in FIG. 24 shows “−2” indicating the airframe noise level causing a refund, corresponding to the airframe noise level 15 dB lower than the airframe noise level that satisfies the environmental standards related to the noise regulations. The charging information 340 illustrated in FIG. 24 shows “+1” indicating the airframe noise level causing a charge, corresponding to the airframe noise level that satisfies the environmental standards related to the noise regulations. The charging information 340 illustrated in FIG. 24 shows “x” indicating infeasible flight, corresponding to the airframe noise level that does not satisfy the environmental standards related to the noise regulations.

For example, according to the examples of FIGS. 20 and 21, the corridors 11 and 14 enable the aviation of the flight vehicle 200 generating an airframe noise (sound pressure) level of 75 dB or less at the distance of 1 m during the daytime. When the flight vehicle 200 flies through the corridors 11 and 14 during the daytime, the airframe noise level of 75 dB satisfies the environmental standards related to the noise regulations according to the examples of FIGS. 20 and 21. When the flight vehicle 200 generating the airframe noise level of 75 dB flies through the corridors 11 and 14 during the daytime, the operation management device 100 charges the flight vehicle 200 by “+1.” When the flight vehicle 200 generating the airframe noise level of 65 dB flies through the corridors 11 and 14 during the daytime, the operation management device 100 refunds the flight vehicle 200 by “−1.”

Consequently, the operation management device 100 can create an incentive so that the flight vehicle 200 even generating the same airframe noise level can fly through the corridors that are situated closer to the center of the road and cause a smaller charged amount or a larger refunded amount. Therefore, the operation management device 100 can further reduce noise at sites close to roads and promote the introduction of quieter flight vehicles 200 in the long term.

The first through seventh embodiments above have explained the operation management device 100 that settles the flight routes of the flight vehicle 200 flying in the air as a 3D space. The operation management device 100 can also be applied to the settlement of migration paths for various mobile objects such as vehicles or robots moving in a 2D space.

### [Others]

It should be noted that the present invention is not limited to the embodiments described above, and includes various modifications. For example, the embodiments described above have been described in detail to simply describe the present invention, and are not necessarily required to include all the described configurations. In addition, part of the configuration of one embodiment can be replaced with the configurations of other embodiments, and, the configuration of the one embodiment can also be added with the configurations of other embodiments. In addition, part of the configuration of each of the embodiments can be subjected to addition, deletion, and replacement with respect to other configurations.

The above-described configurations, functions, processing portions, and processing means, for example, may be embodied as hardware by designing all or part thereof as integrated circuits, for example. The above-described configurations and functions, for example, may be embodied as software by allowing the processor to interpret and execute a program that embodies each function. Information such as programs, tables, or files to embody each function can be stored in storage devices such as memory, hard disk, and SSD (Solid State Drive) or in recording media such as IC card, SD card, and DVD.

Control lines and information lines are illustrated as necessary for explanation and do not completely show all control lines and information lines needed for the product. It may be favorable to consider that almost all configurations are interconnected practically.

### LIST OF REFERENCE SIGNS

100: operation management device, 200: flight vehicle, 310: flyable domain information, 320: airframe noise level information, r, rv: isolation distance

1. An operation management device that settles a flight route of a flight vehicle and performs operation management on the flight vehicle,
wherein airframe noise level information is preliminarily set for each of the flight vehicles to indicate an airframe noise level as a level of noise emitted from the flight vehicle; and
wherein a flyable domain is identified to indicate an air area in which the flight vehicle can fly, according to the airframe noise level of the flight vehicle for which the flight route is to be settled, and the flight route of the flight vehicle is settled based on the identified flyable domain.

2. The operation management device according to claim 1,
wherein an isolation distance is preliminarily set for each of the airframe noise levels to indicate a distance by which the flight vehicle needs to be isolated from a site adjacent to an air area; and
wherein the flyable domain of the flight vehicle is identified based on the isolation distance corresponding to the airframe noise level of the flight vehicle for which the flight route is to be settled.

3. The operation management device according to claim 2,
wherein the isolation distance is set to different values depending on the usage or type of the site.

4. The operation management device according to claim 2,
wherein the isolation distance is set to different values depending on whether there is a wall adjacent to the flight vehicle.

5. The operation management device according to claim 2,
wherein the isolation distance is set to different values depending on the flight time window of the flight vehicle.

6. The operation management device according to claim 2,
wherein the isolation distance is set to different values depending on the directivity of the noise emitted from the flight vehicle.

7. The operation management device according to claim 2,
wherein the isolation distance is set to different values depending on the flight phase of the flight vehicle.

8. The operation management device according to claim 2,
wherein the isolation distance is set to different values depending on the total weight of the flight vehicle.

9. The operation management device according to claim 1,
wherein the airframe noise level is related to the noise measured by using a frequency weighting characteristic that considers human hearing.
